(19) United States
(12) Patent Application Publication
(10) Pub. No.: US 2014/0085299 A1
(43) Pub. Date: Mar. 27, 2014

(54) DISPLAYING UNDERDEFINED FREEDOMS IN A PARTLY-CONSTRAINED GEOMETRY MODEL USING A HANDHELD DEVICE

(71) Applicant: Siemens Product Lifecycle Management Software Inc., (US)

(72) Inventor: Michael James Atkins, Cambridge (GB)

(73) Assignee: SIEMENS PRODUCT LIFECYCLE MANAGEMENT SOFTWARE INC., Plano, TX (US)

(21) Appl. No.: 13/627,733

(22) Filed: Sep. 26, 2012

(51) Int. Cl. G06T 17/00

(52) U.S. Cl. 345/420

(57) ABSTRACT

Methods for product data management and corresponding systems and computer-readable mediums. A method includes receiving a model including a plurality of geometries, at least one of the geometries being underdefined. The method includes displaying the model and detecting motion using a motion-sensing device. The method includes perturbing at least one of the underdefined geometries in response to the detected motion and according to an unconstrained freedom of that geometry. The method includes displaying the model while perturbing the at least one of the underdefined geometries. The method can be performed by a handheld device.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or “PDM” systems).

### BACKGROUND OF THE DISCLOSURE

PDM systems manage PLM and other data. Improved systems are desirable.

### SUMMARY OF THE DISCLOSURE

Various disclosed embodiments include methods for product data management, corresponding systems, and computer-readable mediums. A method includes receiving a model including a plurality of geometries, at least one of the geometries being underdefined. The method includes displaying the model and detecting motion using a motion-sensing device. The method includes perturbing at least one of the underdefined geometries in response to the detected motion and according to an unconstrained freedom of that geometry. The method includes displaying the model while perturbing the at least one of the underdefined geometries. The method can be performed by a handheld device.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a handheld data processing system in which an embodiment can be implemented;

FIGS. 2A-2E show a simple sketch used to illustrate techniques as described herein; and

FIG. 3 depicts a flowchart of a process in accordance with disclosed embodiments.

### DETAILED DESCRIPTION

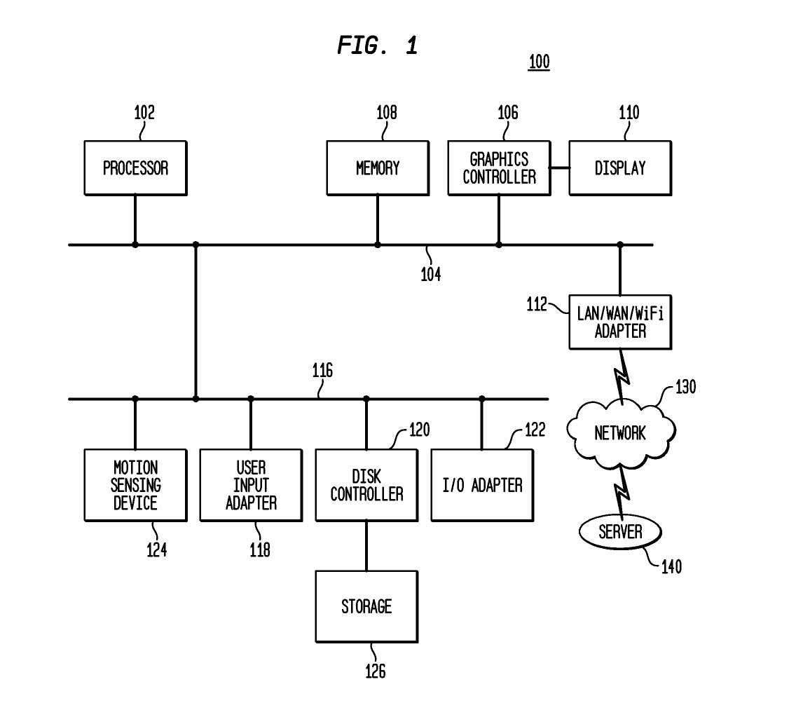

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In a typical PDM or CAD system, a model will contain geometry which is positioned by dimensions and constraints. In addition to applying dimensions and constraints between geometries, it will usually be possible to identify geometry as fixed or grounded. Fixed geometries have no degrees of freedoms and can be used to define a reference frame for the model. If sufficient dimensions and constraints are applied, the unfixed geometry will be rigidly positioned. However, if there are not enough applied dimensions and constraints, then some or all of the unfixed geometries will be “underdefined.” In this case, there are a range of possible geometry positions which satisfy the dimensions and constraints.

Often, a designer will be aiming to produce a design where all the geometry is rigidly positioned so it is important to be able to provide diagnostics for an underdefined model. One way of doing this is to show the designer the freedoms which remain by animating the model through a range of positions which satisfy the constraints.

Some system can apply a “wobble”, which is a pseudo-random perturbation, to each geometry, and in the course of doing this some or all of the dimensions and constraints in the model will become unsatisfied. Typically, this perturbed configuration is not displayed to the user. Next, a Constrained Geometry Solver can be used to solve the perturbed configuration. When such a model is solved, any geometry which is welldefined will, by definition, be solved to the same position every time. However, underdefined geometry will solve to a position that depends on the initial perturbation. By increasing and then decreasing the amplitude of the perturbations in a sinusoidal way the model can be made to sway or “wobble” around its nominal position. This movement can be displayed in order to show the freedoms of the model.

Changing the direction of the initial perturbation will excite freedoms in the model in different ways. So, by cycling through the process with a range of randomly-chosen perturbations multiple freedoms in a model can be displayed.

Disclosed embodiments can display freedoms of a model when displayed on a handheld device, and can be applied not only to the exemplary handheld device 100 described below, but can be implemented using “conventional” mice and touchscreens, which measure movement and position in a 2D space; “3D mice”, which can measure force input, position, or position and velocity; tablet computers and cell phones, which often include accelerometers; and position-sensing devices that measure the 3D position of a human body. While not strictly “handheld”, these devices can perform a similar function as some embodiments disclosed herein.

Disclosed embodiments take advantage of the ability of various devices to determine a 2D or 3D position. In some cases, velocity or acceleration inputs can also or alternatively be used if they are available. In either case, the motion detection described herein can be determined from velocity, acceleration, or from multiple measurements of the position.

As used herein, a “geometry” refers to a basic component of a model (e.g. point, line, circle, etc.). A “constraint” refers to an enforced relationship between two geometries (e.g. parallel, concentric, identical, coincident, etc.). A “dimension” refers to a constraint with an associated value (e.g. distance, radius, angle, etc.). A “Constrained Geometry Solver” can determine a method for computing each geometry position based on its current position and the constraints and dimension upon it. A “freedom” refers to a way in which a geometry can change (e.g., in two dimensions, a circle has two position freedoms and one radius freedom). “Underdefined” refers to a geometry that has some freedom to change. “Welldefined” refers to a geometry that has no freedoms as each attribute has a given value or has all of its freedoms removed by constraints (including dimensions) to other welldefined geometries. A model with underdefined geometries, or an underdefined geometry itself, may be referred to as “partly-constrained”.

FIG. 1 depicts a block diagram of a handheld device 100 in which an embodiment can be implemented, for example as a PDM system particularly configured by software or otherwise to perform the processes as described herein, and in particular as each one of a plurality of interconnected and communicating systems as described herein. The handheld device can be implemented as any type of mobile data processing system configured to perform processes as described herein, including a mobile telephone “smartphone” device, a tablet computer, a laptop computer, or other device. Handheld device 100 includes a processor 102 connected a local system bus 104. Also connected to local system bus in the depicted example are a main memory 108 and a graphics controller 106. The graphics controller 106 may be connected to display 110.

Local system bus 104 can be connected to an input/output (I/O) bus 116. I/O bus 116 is connected to user input adapter 118, which can be any type of user input device, such as a touch-screen, mouse, keyboard, a wireless connection to other input devices, or otherwise. I/O bus 116 can be connected to disk controller 120 that itself can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is a motion-sensing device 124, which can be, for example, a multi-axis accelerometer or other kinematic device that can sense the movement, orientation, or position of the handheld device 100. In other embodiments, motion-sensing device can include a device capable of determining the position of the handheld device 100, and multiple position measurements can be used to detect motion as described herein.

Those of ordinary skill in the art will appreciate that the hardware depicted in FIG. 1 may vary for particular implementations. For example, other peripheral devices, such as an optical disk drive, an audio adapter, speakers, a keyboard/mouse adapter, trackball, trackpointer, and others, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system may permit multiple display windows to be presented in the graphical user interface simultaneously, with each display window providing an interface to a different application or to a different instance of the same application.

Handheld device 100 can include a LAN/WAN/Wireless adapter 112 that can be connected to a network 130, which can be any public or private data processing system network or combination of networks, as known to those of skill in the art, including the Internet. Handheld device 100 can communicate over network 130 with server system 140, which can be implemented, for example, as a separate data processing system.

Disclosed embodiments can use the kinematic input of the device to “wobble” an underdefined model in a way that is intuitive to the user. While specific examples are described below in terms of a two-dimensional model, the techniques described herein apply to any model or sketch, whether two-dimensional or three-dimensional.

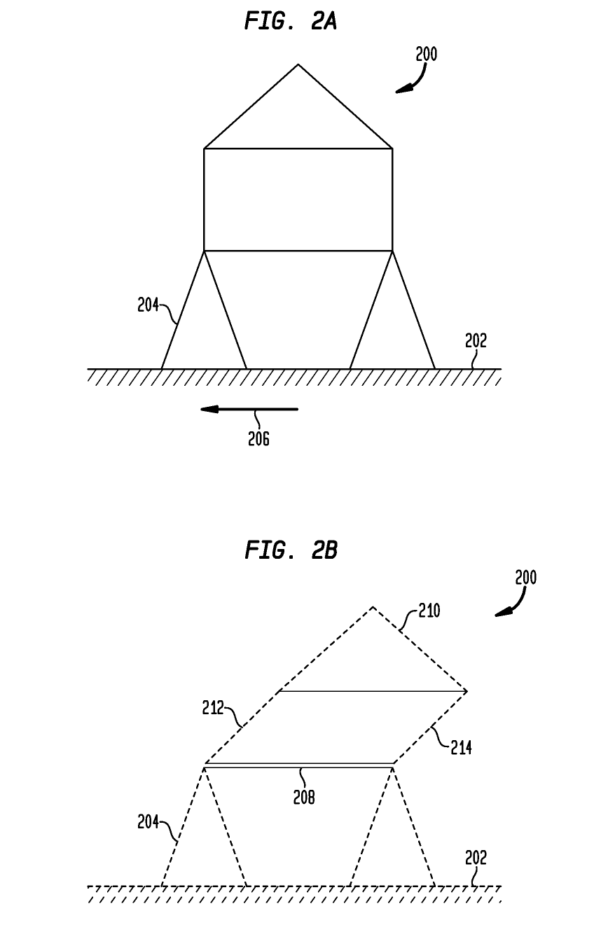

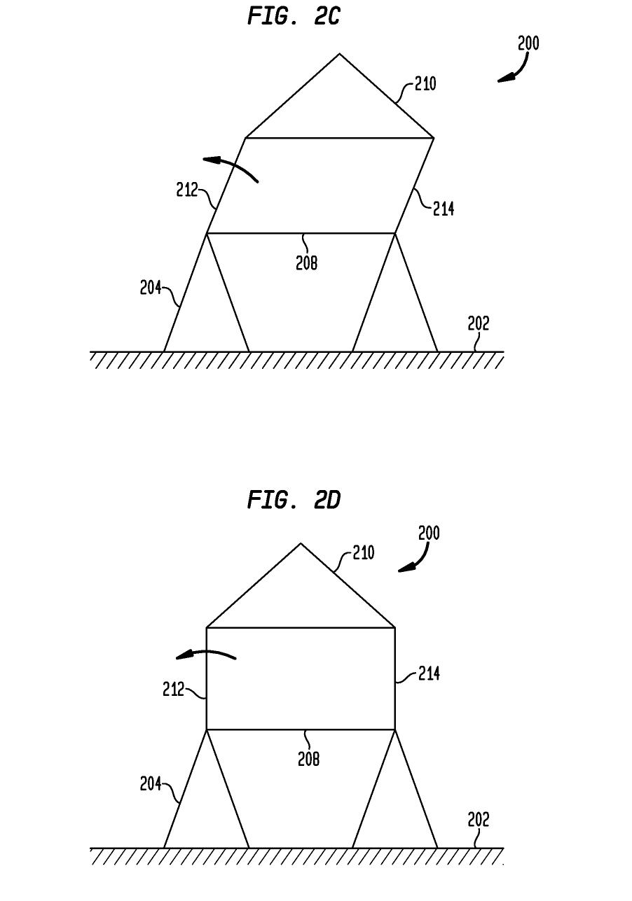

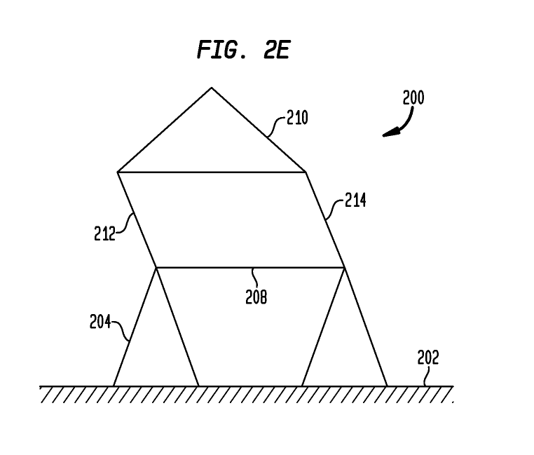

FIGS. 2A-2E show a simple sketch used to illustrate techniques as described herein.

For example, a tablet computer or other handheld device can be used to create and display a 2D sketch, such as sketch 200 illustrated in FIG. 2A. Geometry such as points, lines, and arcs can be input, perhaps by using the touch screen. Certain geometries can be designated as “fixed” or “grounded” which means they have no freedoms and their position cannot be changed. Dimensions and constraints can be added between the geometries, including onto geometries which are fixed. For example, in FIG. 2A, assume that the length dimensions of all lines are specified numeric values, and the “legs” 204 are fixed with respect to the ground 202. The user or designer wishes to determine which geometries of the model are underdefined in that they still have unconstrained freedoms.

At any time during the design process, the user can shake the tablet, move it back-and-forth, move it linearly or rotationally, or otherwise reposition it, and this will result in the model wobbling around its current nominal position. This will show the user freedoms which remain in the model. In this example, the user changes the position of the handheld device by moving it to the left, as illustrated by arrow 206. As described above, the change of position can be moving the handheld device to the left, shaking it, or providing another similar input such as moving a mouse in a certain manner. The change in position or other action results in an input from the motion-sensing device 124.

The input from the motion-sending device 124 can be used in various ways. On a tablet computer, the movement input by the user can be converted into a perturbation which is applied to all the fixed geometry in the model. The CAD system then solves the constraints and dimensions and any geometry which is welldefined with respect to the fixed geometry will get the same perturbation transform. Depending on the perturbation and the freedoms of the model, underdefined geometry can get a different transform. This is similar to what happens in an earthquake, where the ground may move and buildings may sway.

On a system with a mouse or other input device which is separate from the display, the movement of the mouse can be converted to a perturbation which is applied to all the unfixed geometries. This configuration would be solved and the freedoms displayed in a similar way. This is similar to what happens in a strong wind, where a building is blown sideways and then sways back.

FIG. 2B shows a possible result of such a movement. In this case as the handheld device is moved left, the fixed legs 204 and ground 202 remain in position, along with the line 208 connecting the legs 204. The triangle 210, however, “sways” on lines 212 and 214 with respect to the legs 204 and the ground 202. This can indicate that lines 212 and 214 are not constrained in their angle with respect to any support geometry such as line 208 and ground 202. The designer can then determine, for example, that lines 212 or 214 should be constrained as being orthogonal to line 208.

In both the above, the magnitude of the perturbation applied to the model can start from zero (so the model will remain in its nominal position) and then increase gradually in a number of steps. After reaching a maximum value the perturbation can then be decreased gradually back to zero. Such a change in the perturbation can result in the displayed model “swaying” in the appropriate direction; the opposite perturbation would result in swaying in the other direction.

FIG. 2C illustrates the top of model 200 “swaying” back upright, as lines 212 and 214 rotate counter-clockwise about their connection with line 208, carrying triangle 210 with them. Ground 202 and legs 204 remain in place.

FIG. 2D illustrates the top of model 200 as it passes back through its original position. Lines 212 and 214 continue to rotate counter-clockwise about their connection with line 208, carrying triangle 210 with them. Ground 202 and legs 204 remain in place.

FIG. 2E illustrates the top of model 200 as it has swayed to the left. Lines 212 and 214 continue to rotate counter-clockwise about their connection with line 208, carrying triangle 210 with them. Ground 202 and legs 204 remain in place.

The same user input can be used to perturb the geometry cyclically around the nominal position to give the impression of swaying as illustrated above. A sinusoidal variation is one way of doing this.

The perturbation can be damped so the amplitude decreases over time, so that the model eventually returns to its nominal or “home” state.

An application could allow the user to input a new perturbation while the model is being changed, such as by shaking or moving the handheld device again or in a different direction. This could either be used to initiate a new movement of the model, or the new and the old perturbations can be combined.

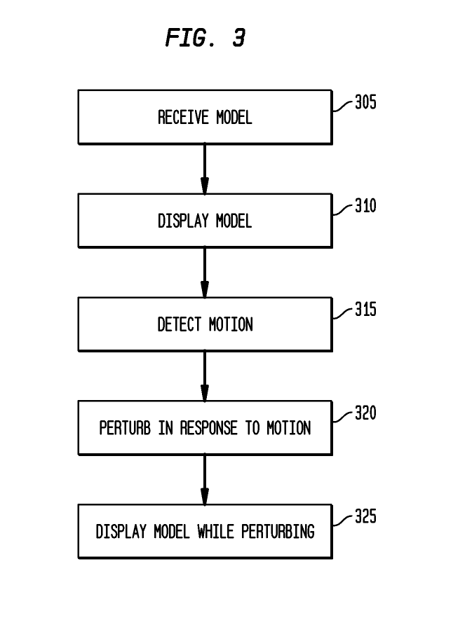

FIG. 3 depicts a flowchart of a process in accordance with disclosed embodiments. This method can be performed, for example, by a handheld device as described herein, referred to generically as the “system” or a “data processing system”.

The system receives a model (step 305). The model can be a 2D or 3D model, and includes a plurality of geometries, at least one of the geometries being underdefined. “Receiving”, as used herein, can include loading from storage, receiving from another device or process, or otherwise.

The system displays the model (step 310).

The system detects motion using a motion-sensing device (step 315). This can be detected in any of the ways described herein, including detecting a change in position of the system, detecting movement of the device using an accelerometer, detecting a change in orientation of the device, and otherwise. The detected motion can be a shaking of the system by a user.

In response to the detected motion, the system perturbs at least one underdefined geometry according to an unconstrained freedom of that geometry (step 320).

The system displays the model while perturbing the at least one underdefined geometry (step 325). This step can include displaying a varying perturbation by moving a portion of the model according to the unconstrained freedom of the at least one underdefined geometry.

Of course, those of skill in the art will recognize that, unless specifically indicated or required by the sequence of operations, certain steps in the processes described above may be omitted, performed concurrently or sequentially, or performed in a different order. Any of the other features and processes described above can be included in the process of FIG. 3.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for displaying underdefined freedoms in a partly-constrained geometry model, the method performed by a data processing system and comprising:
receiving a model including a plurality of geometries, at least one of the geometries being underdefined;
displaying the model;
detecting motion using a motion-sensing device;
perturbing at least one of the underdefined geometries in response to the detected motion and according to an unconstrained freedom of that geometry; and
displaying the model while perturbing the at least one of the underdefined geometries.

2. The method of claim 1, wherein the motion-sensing device includes an accelerometer.

3. The method of claim 1, wherein the motion-sensing device is one of a 2D mouse or a 3D mouse, and measures motion by detecting a change in position over time.

4. The method of claim 1, wherein the data processing system is one of a tablet computer or a smartphone, and the motion-sensing device detects movement of the data processing system as a whole.

5. The method of claim 1, wherein the detected motion is one of a shaking of the data processing system, a trackpad input, a touchscreen input, or a detected body position.

6. The method of claim 1, wherein the data processing system displays a varying perturbation by moving a portion of the model according to the unconstrained freedom of the at least one underdefined geometry.

7. The method of claim 1, wherein the at least one underdefined geometry is perturbed cyclically around a nominal position so that the at least one underdefined geometry is displayed as swaying.

8. A data processing system comprising:
a processor;
a motion-sensing device; and
an accessible memory, the data processing system particularly configured to
receive a model including a plurality of geometries, at least one of the geometries being underdefined;
display the model;
detect motion using the motion-sensing device;
perturb at least one of the underdefined geometries in response to the detected motion and according to an unconstrained freedom of that geometry; and
display the model while perturbing the at least one of the underdefined geometries.

9. The data processing system of claim 8, wherein the motion-sensing device includes an accelerometer.

10. The data processing system of claim 8, wherein the motion-sensing device is one of a 2D mouse or a 3D mouse, and measures motion by detecting a change in position over time.

11. The data processing system of claim 8, wherein the data processing system is one of a tablet computer or a smartphone, and the motion-sensing device detects movement of the data processing system as a whole.

12. The data processing system of claim 8, wherein the detected motion is one of a shaking of the data processing system, a trackpad input, a touchscreen input, or a detected body position.

13. The data processing system of claim 8, wherein the data processing system displays a varying perturbation by moving a portion of the model according to the unconstrained freedom of the at least one underdefined geometry.

14. The data processing system of claim 8, wherein the at least one underdefined geometry is perturbed cyclically around a nominal position so that the at least one underdefined geometry is displayed as swaying.

15. A non-transitory computer-readable medium encoded with executable instructions that, when executed, cause one or more data processing systems to:
receive a model including a plurality of geometries, at least one of the geometries being underdefined;
display the model;
detect motion using the motion-sensing device;
perturb at least one of the underdefined geometries in response to the detected motion and according to an unconstrained freedom of that geometry; and
display the model while perturbing the at least one of the underdefined geometries.

16. The computer-readable medium of claim 15, wherein the motion-sensing device includes an accelerometer.

17. The computer-readable medium of claim 15, wherein the motion-sensing device is one of a 2D mouse or a 3D mouse, and measures motion by detecting a change in position over time.

18. The computer-readable medium of claim 15, wherein the data processing system is one of a tablet computer or a smartphone, and the motion-sensing device detects movement of the data processing system as a whole.

19. The computer-readable medium of claim 15, wherein the data processing system displays a varying perturbation by moving a portion of the model according to the unconstrained freedom of the at least one underdefined geometry.

20. The computer-readable medium of claim 15, wherein the at least one underdefined geometry is perturbed cyclically around a nominal position so that the at least one underdefined geometry is displayed as swaying.
